(19) United States
(12) Patent Application Publication
(10) Pub. No.: US 2012/0108690 A1
(43) Pub. Date: May 3, 2012

(54) METHOD FOR PRODUCING FLAME-RETARDANT POLYURETHANE FOAM MATERIALS HAVING GOOD LONG-TERM USE PROPERTIES

(75) Inventors: Bert Klesczewski, Koln (DE); Manduela Otten, Leverkusen (DE); Sven Meyer-Ahrens, Leverkusen (DE)

(73) Assignee: Bayer MaterialScience AG, Leverkusen (DE)

(21) Appl. No.: 13/382,776

(22) PCT Filed: Jul. 6, 2010
(86) PCT No.: PCT/EP2010/004110

§ 371 Date: Jan. 6, 2012

(30) Foreign Application Priority Data
Jul. 9, 2009 (DE) 10 2009 032 415.1

(51) Int. Cl. C08J 9/00

(52) U.S. Cl. 521/106

(57) ABSTRACT

The subject-matter of the present invention relates to a process for the production of flame-retardant polyurethane foams, preferably for the production of flame-retardant flexible polyurethane foams, from
A1 a filler-containing polyether polyol (component A1.1), wherein the filler is a reaction product of a di- or poly-isocyanate with a compound containing isocyanate-reactive hydrogen atoms, and
   optionally further compounds containing isocyanate-reactive hydrogen atoms and having a molecular weight of from 400 to 18,000 (component A1.2),
A2 optionally compounds containing isocyanate-reactive hydrogen atoms and having a molecular weight of from 62 to 399,
A3 water and/or physical foaming agents,
A4 red phosphorus,
A5 optionally auxiliary substances and additives such as
   a) catalysts,
   b) surface-active additives,
   c) one or more additives selected from the group consisting of reaction retardants, cell regulators, pigments, colourings, flame retardants other than component A4, stabilisers against the effects of ageing and weathering, plasticisers, substances having fungistatic and bacteriostatic action, fillers and release agents,
      and

B di- or poly-isocyanates,

wherein no ammonium polyphosphate is used,
wherein the resulting polyurethane foams exhibit excellent ageing properties as well as a high level of flame-retardant properties.

The subject-matter of the present invention relates to a process for the production of flame-retardant polyurethane foams, in particular flame-retardant flexible polyurethane foams, wherein the resulting flame-retardant polyurethane foams have good long-term use properties.

JP-A 10-147623 discloses halogen-free flame-retardant-containing flexible polyurethane foams containing a combination of red phosphorus and ammonium polyphosphate as well as optionally expandable graphite. The resulting flexible polyurethane foams have the technical disadvantage that they exhibit unsatisfactory ageing properties as well as inadequate flame-retardant properties.

There was a great need to provide flame-retardant polyurethane foams which have both excellent ageing properties and a high level of flame-retardant properties, that is to say in particular the flame retardation requirements according to British Standard 5852, Part 2, Crib V are to be met and a good level of compression set values is to be achieved.

This object is achieved, surprisingly, by a process for the production of flame-retardant polyurethane foams, preferably for the production of flame-retardant flexible polyurethane foams, from
A1 a filler-containing polyether polyol (component A1.1), wherein the filler is a reaction product of a di- or poly-isocyanate with a compound containing isocyanate-reactive hydrogen atoms, and
   optionally further compounds containing isocyanate-reactive hydrogen atoms and having a molecular weight of from 400 to 18,000 (component A1.2),
A2 optionally compounds containing isocyanate-reactive hydrogen atoms and having a molecular weight of from 62 to 399,
A3 water and/or physical foaming agents,
A4 red phosphorus,
A5 optionally auxiliary substances and additives such as
   a) catalysts,
   b) surface-active additives,
   c) one or more additives selected from the group consisting of reaction retardants, cell regulators, pigments, colourings, flame retardants other than component A4, stabilisers against the effects of ageing and weathering, plasticisers, substances having fungistatic and bacteriostatic action, fillers and release agents,
      and

B di- or poly-isocyanates,

wherein no ammonium polyphosphate is used.

The process of the present invention accordingly differs from JP-A 10-147623 in particular in that no ammonium polyphosphate is used as flame retardant.

The present invention provides in particular a process for the production of polyurethane foams, preferably for the production of flexible polyurethane foams, from

component A:
A1 100 parts by weight of one or more filler-containing polyether polyols (A1.1), wherein the filler is a reaction product of a di- or poly-isocyanate with a compound containing isocyanate-reactive hydrogen atoms, or
   of a mixture of
      A1.1 filler-containing polyether polyol (A1.1), wherein the filler is a reaction product of a di- or poly-isocyanate with a compound containing isocyanate-reactive hydrogen atoms, and
      A1.2 further compounds containing isocyanate-reactive hydrogen atoms and having a molecular weight of from 400 to 18,000,
A2 from 0 to 10 parts by weight, preferably from 0 to 2 parts by weight (based on component A1), of compounds containing isocyanate-reactive hydrogen atoms and having a molecular weight of from 62 to 399,
A3 from 0.5 to 25 parts by weight, preferably from 2 to 5 parts by weight (based on component A1), of water and/or physical foaming agents,
A4 from 1 to 9 parts by weight, preferably from 2 to 7 parts by weight, particularly preferably from 3 to 6 parts by weight (based on the sum of components A1), of red phosphorus,
A5 from 0 to 15 parts by weight, preferably from 0.1 to 4 parts by weight (based on component A1), of auxiliary substances and additives such as
   a) various catalysts,
   b) surface-active additives,
   c) one or more additives selected from the group consisting of reaction retardants, cell regulators, pigments, colourings, flame retardants other than component A4, stabilisers against the effects of ageing and weathering, plasticisers, substances having fungistatic and bacteriostatic action, fillers and release agents,

and

component B:

B di- or poly-isocyanates,

wherein no ammonium polyphosphate is used, and
wherein the production is carried out at an index of from 50 to 250, preferably from 70 to 150, particularly preferably from 95 to 125.

The parts by weight of components A2 to A5 indicated in the present application accordingly relate to 100 parts by weight of the parts by weight of component A1.

In a preferred embodiment of the invention, no melamine is used in the process. In a particularly preferred embodiment of the invention, no melamine and/or no expanded graphite is used. In a most preferred embodiment of the invention, no further flame retardant is used in the process apart from red phosphorus.

The production of foams based on isocyanates is known per se and described, for example, in DE-A 1 694 142, DE-A 1 694 215 and DE-A 1 720 768 as well as in Kunststoff-Handbuch Volume VII, Polyurethane, edited by Vieweg and Höchtlein, Carl Hanser Verlag, Munich 1966, as well as in the new edition of that book, edited by G. Oertel, Carl Hanser Verlag Munich, Vienna 1993.

They are predominantly foams containing urethane and/or uretdione and/or urea and/or carbodiimide groups. The use according to the invention preferably takes place in the production of polyurethane and polyisocyanurate foams.

The components described in greater detail hereinbelow can be used in the production of isocyanate-based foams.

### Component A1

Starting components according to component A1.1 are filler-containing polyether polyols, wherein the filler is a reaction product of a di- or poly-isocyanate with a compound containing isocyanate-reactive hydrogen atoms.

For the process according to the invention, the filler-containing polyether polyols according to component A1.1 preferably have a filler structure of
A1.1.1 polyurea dispersions obtained by reaction of diamines and diisocyanates in the presence of the polyol component A1.2 (PHD dispersions)
   and/or
A1.1.2 dispersions containing urethane groups, obtained by reaction of alkanolamines and diisocyanates in the polyol component A1.2 (PIPA polyols).

The filler-containing polyether polyols according to component A1.1.1 (PHD dispersion) are prepared, for example, by in situ polymerisation of an isocyanate or isocyanate mixture with a diamine and/or hydrazine in a polyol according to component A1.2, preferably in a polyether polyol. The PHD dispersion is preferably prepared by reaction of an isocyanate mixture comprising from 75 to 85 wt. % 2,4-toluene diisocyanate (2,4-TDI) and from 15 to 25 wt.% 2,6-toluene diisocyanate (2,6-TDI) with a diamine and/or hydrazine in a polyether polyol, preferably in a polyether polyol prepared by alkoxylation of a trifunctional starter (such as, for example, glycerol and/or trimethylolpropane). Processes for the preparation of PHD dispersions are described, for example, in U.S. Pat. No. 4,089,835 and U.S. Pat. No. 4,260,530.

The filler-containing polyether polyols according to component A1.1.2 are preferably PIPA (polyisocyanate polyaddition with alkanolamines)-modified polyether polyols, wherein the polyether polyol has a functionality of from 2.5 to 4 and a molecular weight of from 500 to 18,000.

Starting components according to component A1.2 are compounds with at least two isocyanate-reactive hydrogen atoms having a molecular weight of generally from 400 to 18,000. In addition to compounds containing amino groups, thio groups or carboxyl groups, these are preferably to be understood as being compounds containing hydroxyl groups, in particular from 2 to 8 hydroxyl groups, especially those having a molecular weight of from 1000 to 6000, preferably from 2000 to 6000, for example polyethers and polyesters containing at least 2, generally from 2 to 8, but preferably from 2 to 6, hydroxyl groups, as well as polycarbonates and polyester amides, as are known per se for the preparation of homogeneous and cellular polyurethanes and as are described, for example, in EP-A 0 007 502, pages 8-15. Preference is given according to the invention to polyether polyols containing at least two hydroxyl groups. The polyether polyols are preferably prepared by addition of alkylene oxides (such as, for example, ethylene oxide, propylene oxide and butylene oxide or mixtures thereof) to starters such as ethylene glycol, propylene glycol, glycerol, trimethylolpropane, pentaerythritol, sorbitol, mannitol and/or sucrose, so that a functionality of from 2 to 8, preferably from 2.5 to 6, particularly preferably from 2.5 to 4, can be established.

Component A1 can also contain as component A1.3 filled polyether polyols having a filler structure comprising dispersions which are obtained by grafting olefinically unsaturated monomers (for example styrene and/or acrylonitrile) to a polyether polyol (such as, for example, a polyether polyol according to component A1.2) (SAN polyols), these being used in amounts such that the filler content, based on polyol component A1 containing A1.1 and A1.2, is up to 5 wt. %, preferably up to 2 wt. % filler (resulting from component A1.3). In a preferred embodiment, no filled polyether polyol that has a filler structure comprising dispersions (component A1.3) obtained by grafting olefinically unsaturated monomers such as styrene and/or acrylonitrile to the polyol component A1.2 (SAN polyols) is used in the process according to the invention.

In a preferred embodiment there are used as component A components A1.1 and A1.2 in a weight ratio of A1.1:A1.2=100:0 to 20:80, particularly preferably in a weight ratio of A1.1:A1.2=100:0 to 60:40. Most preferably, only component A1.1 is used as component A (that is to say starting components according to component A1.2 are most preferably not used in the preparation process).

The filler content, based on the polyol component Al containing A1.1.1, A1.1.2 and optionally A1.2, is preferably from 2 to 30 wt. %, particularly preferably from 5 to 25 wt. %, most preferably from 15 to 22 wt. %, filler PHD and/or PIPA. Because the filler dispersions A1.1 are generally prepared with a filler content of from 10 to 40 wt. %, this is accordingly to be taken into account. For example, in the case of a filler content of 20 wt. % of component A1.1 and a ratio of 75 parts by weight of A1.1 and 25 parts by weight of A1.2, a filler content of 15 wt. %, based on the polyol component A1, is obtained.

### Component A2

There are optionally used as component A2 compounds having at least two isocyanate-reactive hydrogen atoms and a molecular weight of from 32 to 399. These are to be understood as being compounds containing hydroxyl groups and/or amino groups and/or thiol groups and/or carboxyl groups, preferably compounds containing hydroxyl groups and/or amino groups, which serve as chain extenders or crosslinkers. These compounds generally contain from 2 to 8, preferably from 2 to 4, isocyanate-reactive hydrogen atoms. For example, there can be used as component A2 ethanolamine, diethanolamine, triethanolamine, sorbitol and/or glycerol. Further examples of compounds according to component A2 are described in ERA 0 007 502, pages 16-17.

### Component A3

Water and/or physical foaming agents are used as component A3. As physical foaming agents there are used, for example, carbon dioxide and/or readily volatile organic substances such as, for example, dichloromethane.

### Component A4

Component A4 is red phosphorus.

Red phosphorus is preferably used in the process according to the invention in the form of a solid dispersed in liquids. Liquids suitable therefor (within the scope of the invention these are understood as being substances whose melting point is below 25° C.) include on the one hand those which contain isocyanate-reactive groups, for example polyether polyols, polyester polyols, castor oil, and on the other hand those which do not contain isocyanate-reactive groups but are distinguished by the fact that they permit both good dispersion of the red phosphorus and further processing to the foam. Examples of the latter are, for example, phenolalkylsulfonic acid esters (trade name e.g. Mesamoll®, Lanxess AG, Leverkusen), adipic acid polyesters (trade name e.g. Ultramoll®, Lanxess AG, Leverkusen) or phthalic acid esters such as, for example, diisooctyl phthalate, dibutyl phthalate.

### Component A5

As component A5 there are optionally used auxiliary substances and additives such as
a) catalysts (activators),
b) surface-active additives (surfactants), such as emulsifiers and foam stabilisers,
c) one or more additives selected from the group consisting of reaction retardants (e.g. acid-reacting substances such as hydrochloric acid or organic acid halides), cell regulators (such as, for example, paraffins or fatty alcohols or dimethylpolysiloxanes), pigments, colourings, flame retardants other than component A4 (such as, for example, tricresyl phosphate), stabilisers against the effects of ageing and weathering, plasticisers, substances having fungistatic and bacteriostatic action, fillers (such as, for example, barium sulfate, kieselguhr, carbon black or precipitated chalk) and release agents.

These auxiliary substances and additives which are optionally to be used concomitantly are described, for example, in EP-A 0 000 389, pages 18-21. Further examples of auxiliary substances and additives which are optionally to be used concomitantly according to the invention as well as details of the manner of use and mode of action of such auxiliary substances and additives are described in Kunststoff-Handbuch, Volume VII, edited by G. Oertel, Carl-Hanser-Verlag, Munich, 3rd edition, 1993, for example on pages 104-127.

As catalysts there are preferably used: aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza(2,2,2)bicyclooctane), aliphatic amino ethers (for example bisdimethylaminoethyl ether, 2-(2-dimethylaminoethoxy)-ethanol and N,N,N-trimethyl-N-hydroxyethyl-bisaminoethyl ether), cycloaliphatic aminoethers (for example N-ethylmorpholine), aliphatic amidines, cycloaliphatic amidines, urea and derivatives of urea (such as, for example, aminoalkylureas, see, for example, EP-A 0 176 013, in particular (3-dimethylaminopropylamine)-urea).

There can also be used as catalysts tin(II) salts of carboxylic acids, the underlying carboxylic acid in each case preferably having from 2 to 20 carbon atoms. Particular preference is given to the tin(II) salt of 2-ethylhexanoic acid (i.e. tin(II) 2-ethylhexanoate), the tin(II) salt of 2-butyloctanoic acid, the tin(II) salt of 2-hexyldecanoic acid, the tin(II) salt of neodecanoic acid, the tin(II) salt of oleic acid, the tin(II) salt of ricinoleic acid and tin(II) dilaurate. Tin(IV) compounds, such as, for example, dibutyltin oxide, dibutyltin dichloride, dibutyltin diacetate, dibutyltin dilaurate, dibutyltin maleate or dioctyltin diacetate, can also be used as catalysts.

All the above-mentioned catalysts can, of course, be used in the form of mixtures.

### Component B

As component B there are used aliphatic, cycloaliphatic, araliphatic, aromatic and heterocyclic polyisocyanates, as are described, for example, by W. Siefken in Justus Liebigs Annalen der Chemie, 562, pages 75 to 136, for example those of formula (I)

Q(NCO)ₙ (I)

in which
n=2-4, preferably 2-3,
and
Q denotes an aliphatic hydrocarbon radical having from 2 to 18, preferably from 6 to 10, carbon atoms, a cycloaliphatic hydrocarbon radical having from 4 to 15, preferably from 6 to 13, carbon atoms, or an araliphatic hydrocarbon radical having from 8 to 15, preferably from 8 to 13, carbon atoms.

They are, for example, polyisocyanates as are described in EP-A 0 007 502, pages 7-8. Particular preference is generally given to the polyisocyanates which are readily obtainable industrially, for example 2,4- and 2,6-toluene diisocyanate as well as arbitrary mixtures of these isomers (“TDI”); polyphenylpolymethylene polyisocyanates, as are prepared by aniline-formaldehyde condensation and subsequent phosgenation (“crude MDI”), and polyisocyanates containing carbodiimide groups, urethane groups, allophanate groups, isocyanurate groups, urea groups or biuret groups (“modified polyisocyanates”), in particular those modified polyisocyanates which are derived from 2,4- and/or 2,6-toluene diisocyanate or from 4,4′- and/or 2,4′-diphenylmethane diisocyanate. There is preferably used as component B at least one compound selected from the group consisting of 2,4- and 2,6-toluene diisocyanate, 4,4′- and 2,4′- and 2,2′-diphenylmethane diisocyanate and polyphenylpolymethylene polyisocyanate (“polynuclear MDI”).

### Carrying Out the Process for the Production of Polyurethane Foams

The polyurethane foams can be produced by various processes of slabstock foam production or in moulds. For carrying out the process according to the invention, the reaction components are reacted by the one-shot process known per se, the prepolymer process or the semi-prepolymer process, use preferably being made of mechanical devices as are described in U.S. Pat. No. 2,764,565. Details of processing devices which are also suitable according to the invention are described in Vieweg and Höchtlen (eds.): Kunststoff-Handbuch, Volume VII, Carl-Hanser-Verlag, Munich 1966, p. 121 to 205.

In the foam production, foaming can also be carried out according to the invention in closed moulds. The reaction mixture is thereby introduced into a mould. Suitable mould materials are metal, for example aluminium, or plastics, for example epoxy resin. The foamable reaction mixture expands in the mould and forms the moulded body. Foaming in the mould can be carried out so that the moulding has a cellular structure at its surface. However, it can also be carried out so that the moulding has a compact skin and a cellular core. According to the invention, it is possible to proceed in this connection as follows: there is introduced into the mould sufficient foamable reaction mixture that the resulting foam just fills the mould. However, it is also possible to introduce more foamable reaction mixture into the mould than is necessary to fill the inside of the mould with foam. In the last-mentioned case, the operation is accordingly carried out with so-called “overcharging”; such a procedure is known, for example, from U.S. Pat. No. 3,178,490 and U.S. Pat. No. 3,182,104.

In the case of foaming in the mould, “external release agents” known per se, such as silicone oils, are in many cases used concomitantly. It is, however, also possible to use so-called “internal release agents”, optionally in admixture with external release agents, as is disclosed, for example, in DE-OS 21 21 670 and DE-OS 23 07 589.

The polyurethane foams are preferably produced by slabstock foaming or by the twin belt conveyor process known per se (see, for example, “Kunststoffhandbuch”, Volume VII, Carl Hanser Verlag, Munich Vienna, 3rd edition 1993, p. 148).

The process according to the invention is preferably used in the production of flexible polyurethane foams having an apparent density (also referred to as mass per unit volume) of from 10 kg m⁻³ to 200 kg m⁻³, particularly preferably from 15 kg m⁻³ to 80 kg m⁻³.

### EXAMPLES

### Component A1:

A1-1 PHD filler polyol of a 20% dispersion of toluene diisocyanate (Desmodur® T 80, BayerMaterialScience AG, Leverkusen, Germany) and hydrazine in a polyether polyol comprising 83 wt. % propylene oxide and 17 wt. % ethylene oxide as well as trimethylolpropane as starter with predominantly primary OH groups, having an OH number of 28 mg KOH/g and a water content of 0.5 wt. %.
A1-2 SAN filler polyol of a 25% dispersion of a polyol, grafted with 60 wt. % acrylonitrile and 40 wt. % styrene, of glycerol as starter and 83 wt. % propylene oxide and 17 wt. % ethylene oxide with predominantly primary OH groups, having an OH number of 31 mg KOH/g.

### Component A2: Diethanolamine (BASF SE, Ludwigshafen, Germany).

### Component A3: Water.

### Component A4:

Red phosphorus: Exolit® RP 6520, a dispersion of red phosphorus in castor oil (Clariant Produkte (Germany) GmbH, 50351 Hürth).

### Component A5:

A5-1 1,4-Diazabicyclo[2.2.2]octane (33 wt. %) in dipropylene glycol (67 wt. %) (Dabco® 33 LV, Air Products, Hamburg, Germany).
A5-2 Tin(II) salt of 2-ethylhexanoic acid (Addocat® SO, Rheinchemie, Mannheim, Germany).
A5-3 Polyether siloxane-based foam stabiliser Tegostab® B 8681 (Evonik Goldschmidt GmbH, Germany).
A5-4 Expanded graphite Expofoil PX 99 (Georg Huh GmbH, 65396 Walluf).
A5-5 Melamine (BASF SE, Ludwigshafen, Germany).
A5-6 Ammonium polyphosphate (Exolite® AP 422, Clariant Produkte (Germany) GmbH, 50351 Hürth).
A5-7 Calcium hydroxide.

### Component B:

Mixture of 2,4- and 2,6-TDI in a weight ratio of 80:20 and having an NCO content of 48 wt.%.

### Production of the Polyurethane Foams

Under the processing conditions conventional for the production of polyurethane foams, the starting components are processed in the one-shot process by means of slabstock foaming. The index of the processing (which gives the amount of component B to be used in relation to component A) is indicated in Table 1. The index (isocyanate index) gives the percentage ratio of the amount of isocyanate actually used to the stoichiometric, i.e. calculated, amount of isocyanate groups (NCO):

Index=[(amount of isocyanate used):(amount of isocyanate calculated)]•100 (II)

The mass per unit area was determined according to DIN EN ISO 845.

The compression load deflection (CLD 40%) was determined according to DIN EN ISO 3386-1-98 at 40% deformation, 4th cycle.

The tensile strength and the elongation at break were determined according to DIN EN ISO 1798.

The compression set (CS 90%) was determined according to DIN EN ISO 1856-2000 at 90% deformation.

Crib 5: Flammability test according to British Standard 5852, Part 5, Crib 5.

TABLE 1
Flexible polyurethane foams, recipes and properties

| | | 1 | | | | | 6 | 7 |
|---|---|---|---|---|---|---|---|---|
| | | (comp.) | 2 | 3 | 4 | 5 | (comp.) | (comp.) |
| A1-1 | | 100 | 100 | 100 | 100 | 100 | | |
| A1-2 | | | | | | | 100 | 100 |
| A2 | | 1.2 | 1.2 | 1.2 | 1.2 | 1.2 | 1.2 | 1.2 |
| A3 (water used) | | 2.0 | 2.0 | 2.0 | 2.0 | 2.0 | 2.5 | 2.5 |
| A3 (water total) | | 2.5 | 2.5 | 2.5 | 2.5 | 2.5 | 2.5 | 2.5 |
| A4 | | | 5.0 | 5.0 | 5.0 | 5.0 | 5.0 | 5.0 |
| A5-1 | | 0.25 | 0.25 | 0.25 | 0.25 | 0.25 | 0.25 | 0.25 |
| A5-2 | | 0.18 | 0.18 | 0.18 | 0.18 | 0.20 | 0.20 | 0.20 |
| A5-3 | | 0.35 | 0.35 | 0.35 | 0.35 | 0.35 | 0.40 | 0.40 |
| A5-4 | | | | 5.0 | 5.0 | | | |
| A5-5 | | | | | 5.0 | 5.0 | | 5.0 |
| B | | 33.98 | 34.65 | 34.65 | 34.65 | 34.70 | 34.50 | 35.10 |
| Index | | 108 | 108 | 108 | 108 | 108 | 108 | 108 |
| Properties | | | | | | | | |
| Apparent | [kg/m³] | 35 | 35.3 | 37.1 | 38.2 | 38.1 | 33.7 | 35.7 |
| density | | | | | | | | |
| Tensile strength | [kPa] | 145 | 123 | 128 | 103 | 114 | 129 | 126 |
| Elongation at | [%] | 120 | 122 | 116 | 104 | 94 | 128 | 113 |
| break | | | | | | | | |
| Compression | [kPa] | 3.19 | 3.09 | 3.43 | 3.41 | 4.41 | 4.54 | 4.15 |
| load deflection | | | | | | | | |
| CS 90% | [%] | 5.5 | 6.8 | 6.1 | 12.6 | 21.1 | 9.4 | 39.7 |
| Crib 5 | passed | no | yes | yes | yes | yes | no | no |

The results given in Table 1 show that only the foams described in Examples 2 to 5 according to the invention satisfy the requirements according to British Standard 5852, Part 5, Crib 5 and exhibit good long-term properties.

TABLE 2
Flexible polyurethane foams, recipes and properties

| | | 8 | 9 |
|---|---|---|---|
| | | (comp.) | (comp.) |
| A1-1 | | 100 | 100 |
| A2 | | 1.2 | 1.2 |
| A3 (water used) | | 2.0 | 2.0 |
| A3 (water total) | | 2.5 | 2.5 |
| A4 | | 5.0 | 5.0 |
| A5-1 | | 0.25 | 0.25 |
| A5-2 | | 0.25 | 0.25 |
| A5-3 | | 0.4 | 0.4 |
| A5-6 | | 5.0 | 5.0 |
| A5-7 | | | 1.0 |
| B | | 34.65 | 34.65 |
| Index | | 108 | 108 |
| Properties | | 1) | |
| Apparent density | [kg/m³] | | 37.2 |
| Tensile strength | [kPa] | | 111 |
| Elongation at break | [%] | | 103 |
| Compression load | [kPa] | | 3.88 |
| deflection | | | |
| CS 90% | [%] | | 20.1 |
| Crib 5 | passed | | no |

1) The rising reaction mixture collapses. It was therefore not possible to determine properties of the polyurethane foam.

The results given in Table 2 show that it is not possible, with the concomitant use of ammonium polyphosphate, to obtain good long-term properties and to satisfy the requirements according to British Standard 5852, Part 5, Crib 5.

1-10. (canceled)

11. Process for the production of flame-retardant polyurethane foams from
A1 a filler-containing polyether polyol (component A1.1), wherein the filler is a reaction product of a di- or poly-isocyanate with a compound containing isocyanate-reactive hydrogen atoms,
A3 water and/or physical foaming agents,
A4 red phosphorus,
and
B di- or poly-isocyanates,
wherein no ammonium polyphosphate is used.

12. Process according to claim 11 for the production of flame-retardant polyurethane foams from component A:
A1 100 parts by weight of one or more filler-containing polyether polyols (A1.1), wherein the filler is a reaction product of a di- or poly-isocyanate with a compound containing isocyanate-reactive hydrogen atoms, or of a mixture of
A1.1 filler-containing polyether polyol, wherein the filler is a reaction product of a di- or poly-isocyanate with a compound containing isocyanate-reactive hydrogen atoms, and
A1.2 further compounds containing isocyanate-reactive hydrogen atoms and having a molecular weight of from 400 to 18,000,
A2 from 0 to 10 parts by weight (based on component A1) of compounds containing isocyanate-reactive hydrogen atoms and having a molecular weight of from 62 to 399,
A3 from 0.5 to 25 parts by weight (based on component A1) of water and/or physical foaming agents,
A4 from 1 to 9 parts by weight (based on component A1) of red phosphorus,
A5 from 0 to 15 parts by weight (based on component A1) of auxiliary substances and additives such as
a) catalysts,
b) surface-active additives,
c) one or more additives selected from the group consisting of reaction retardants, cell regulators, pigments, colourings, flame retardants other than component A4, stabilisers against the effects of ageing and weathering, plasticisers, substances having fungistatic and bacteriostatic action, fillers and release agents,
and component B:
B di- or poly-isocyanates,
wherein no ammonium polyphosphate is used, and
wherein the production is carried out at an index of from 50 to 250.

13. Process according to claim 11, wherein no melamine is used.

14. Process according to claim 11, wherein no expanded graphite is used.

15. Process according to claim 11, wherein no polyether polyols are used that contain a filler structure of dispersions obtained by grafting suitable monomers such as styrene and/or acrylonitrile to a polyether polyol (SAN polyols).

16. Process according to claim 11, wherein component A1.1 is polyether polyols having a filler structure of
A1.1.1 polyurea dispersions obtained by reaction of diamines and diisocyanates in the presence of the polyol component A1.2 (PHD dispersions),
and/or
A1.1.2 dispersions containing urethane groups, obtained by reaction of alkanolamines and diisocyanates in the polyol component A1.2 (PIPA polyols).

17. Process according to claim 11, wherein there are used as component A components A1.1 and A1.2 in a weight ratio of A1.1:A1.2=100:0 to 20:80.

18. Process according to claim 11, wherein only component A1.1 is used as component A.

19. Process according to claim 11, wherein there is used as component A4 red phosphorus in the form of a solid dispersed in at least one liquid selected from the group consisting of polyether polyols, polyester polyols, castor oil, phenolalkylsulfonic acid esters, adipic acid polyesters and phthalic acid esters.

20. Polyurethane foams obtainable by a process according to claim 11.
